(19) United States
(12) Patent Application Publication
(10) Pub. No.: US 2025/0139839 A1
(43) Pub. Date: May 1, 2025

(54) SYSTEMS AND METHODS FOR AUGMENTED REALITY MAPPING

(71) Applicant: State Farm Mutual Automobile Insurance Company, Bloomington, IL (US)

(72) Inventor: Phillip M. Wilkowski, Gilbert, AZ (US)

(21) Appl. No.: 18/637,066

(22) Filed: Apr. 16, 2024

Related U.S. Application Data
(60) Provisional application No. 63/593,590, filed on Oct. 27, 2023.

(51) Int. Cl. G06T 11/00; G01C 21/00

(52) U.S. Cl. CPC G06T 11/00; G01C 21/383

(57) ABSTRACT

A computer system is provided. The computer system may be programmed to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the generated image overlay.

### CROSS-REFERENCE TO RELATED APPLICATIONS

This application claims priority to U.S. Provisional Patent Application No. 63/593,590, filed Oct. 27, 2023, the entire contents and disclosures of which are hereby incorporated herein by reference in its entirety.

### FIELD OF THE DISCLOSURE

The field of the disclosure relates generally to augmented reality mapping, and more specifically, to generating augmented reality interfaces providing locations of components within a building or other structure.

### BACKGROUND

Augmented reality (AR) systems generate sensory outputs, such as graphical overlays on real-time images, that simulates the presence of computer-generated content in the real world. Virtual reality systems (VR) generate sensory outputs such as graphics that give a user an immersive feel of a virtual world. Both AR and VR systems may utilize real-time data, such as positional data relating to the user, to create a user interface that realistically responds to movement and other actions of the user. Accordingly, AR and VR systems may be used to convey information to the user in ways that, compared to traditional ways of conveying information, may be more intuitive to or easily understandable by users.

Homes and other buildings generally require maintenance and repair. Computing devices may be used to retrieve and display information about maintenance and repair. For example, in emergency situations (e.g., fires or burst pipes) and/or situations where the homeowner is not present, others may need information quickly on how to take care of the home or building in view of the emergency.

However, because each home is unique, the types of general information that may be retrieved using computers (e.g., through Internet searches) may not apply to specific homes. For example, locations of specific items and other components of the home or building, and how to fix, maintain, or otherwise care for these components, may be known only to the homeowner. This may be particularly problematic in urgent situations (e.g., fires or burst pipes), where those responding to the situation may need to quickly find items or components within the home (e.g., fire extinguishers, pipes or ducts, valves, tools), and if necessary, learn how to use or fix these items or components.

Conventional techniques may include additional inadequacies, ineffectiveness, encumbrances, inefficiencies, and other drawbacks as well.

### BRIEF DESCRIPTION

The present embodiments may relate to, inter alia, systems and methods for dynamically generating an interface that displays informative information (also referred to herein as building information) to a user. For example, the systems and methods described herein may be configured to generate a user interface that displays information relating to a home or another building or structure, which may be used to quickly address and fix issues (e.g., leaks, electrical issues, heating, ventilation, and air conditioning (HVAC) failures, water heater failures, etc.) associated with the home or building. The interface may be an augmented reality (AR) interface, which may enable a user (e.g., a homeowner, first responder, contractor, or maintenance personnel) to quickly locate components of the home or building and/or items within the home or building (e.g., tools) relevant to fixing an identified issue. The system may include less, or alternate functionality, including that discussed elsewhere herein.

In one aspect, a computer system may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system may be programmed to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the image stream with the generated image overlay. The computer system may include additional, less, or alternate functionality, including that discussed elsewhere herein.

In another aspect, an analytics computing device may be provided. The analytics computing device may include at least one processor and at least one memory device. The at least one processor may be configured to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the image stream with the generated image overlay. The computing device may have additional, less, or alternate functionality, including that discussed elsewhere herein.

In yet another aspect, a computer-implemented method may be provided. The computer-implemented method may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. The computer-implemented method may be performed by a computing device including at least one processor and at least one memory device. The method may include, via the at least one processor: (a) receiving, from a user computing device, a request identifying (i) a building, (ii) an inquiry relating to the building, (iii) positional data relating to a position of the user computing device, and/or (iv) an image stream generated by a camera of the user computing device; (b) retrieving building data relating to the building, the building data indicating a location of a plurality of components of the building; (c) identifying, based upon the inquiry, one or more target components of the plurality of components of the building, the target components relating to the inquiry; (d) generating, based upon the positional data and the building data, an image overlay including one or more indicators corresponding to locations of the one or more target components; and/or (e) causing the user computing device to display the image stream with the generated image overlay. The method may have additional, less, or alternate actions, including that discussed elsewhere herein.

In still another aspect, at least one non-transitory computer readable storage medium having computer-executable instructions embodied thereon may be provided. When executed by at least one processor, the computer-executable instructions cause the at least one processor a to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the image stream with the generated image overlay. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary computer system in accordance with an exemplary embodiment of the present disclosure.

FIG. 2 depicts an exemplary client computing device that may be used with the exemplary computer system illustrated in FIG. 1.

FIG. 3 depicts an exemplary server system that may be used with the exemplary computer system illustrated in FIG. 1.

FIG. 4 an exemplary user interface that may be displayed by the exemplary computer system illustrated in FIG. 1.

FIG. 5A illustrates an exemplary computer-implemented method for generating augmented reality or virtual reality interfaces that provide locations of components within building.

FIG. 5B is a continuation of the exemplary computer-implemented method shown in FIG. 5A.

FIG. 5C is a continuation of the exemplary computer-implemented method shown in FIGS. 5A and 5B.

FIG. 6 illustrates an exemplary computer-implemented method for generating augmented reality or virtual reality interfaces using a chatbot.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for dynamically generating an interface that displays informative information (also referred to herein as building information) to a user. For example, the systems and methods described herein may be configured to generate a user interface that displays information relating to a home or another building or structure, which may be used to quickly address and fix issues (e.g., leaks, electrical issues, heating, ventilation, and air conditioning (HVAC) failures, water heater failures, etc.) associated with the home or building. The interface may be an augmented reality (AR) interface, which may enable a user (e.g., a homeowner, first responder, contractor, or maintenance personnel) to quickly locate components of the home or building and/or items within the home or building (e.g., tools) relevant to fixing an identified issue.

In exemplary embodiments, the systems and methods may be performed by a server computing device or other computing device sometimes referred to as an analytics computing device. The analytics computing device may be configured to receive, from a user computing device, a request message, which may identify a building and an inquiry relating to the building (e.g., a reported issue with the building and/or a question about the building). As used herein, “inquiry” refers to data component defining a request for certain information that may be identified from within the inquiry itself or determined contextually by the system. The request may further include additional data, such as positional data relating to a position of the user computing device (e.g., global positioning system (GPS), accelerometer, and/or gyroscope data indicating a position and/or orientation of the user computing device), an image stream or other images generated by a camera and/or other sensors of the user computing device, and/or other data relevant to providing information about the building.

In some embodiments, issues within the building, such as, for example, leaks, fires, electrical issues, damage, broken appliances, intruders, and/or other such issues, may be detected by sensors and/or smart devices within the building, which may result in the system alerting a user and/or providing information relevant to addressing the detected issue. For example, the building may be a smart home including a building computing device or other hub, which may collect data from sensors around the building and transmit this sensor data to the analytics computing device. Alternatively, in some implementations the analytics computing device may itself be a building computing device or other smart home hub that communicates with sensors in the building. This data may be analyzed to determine if such issues are present in the building or provide other information about the building (e.g., current conditions in the building, which devices are currently installed, where these devices are located).

In exemplary embodiments, the analytics computing device may be further configured to retrieve building data relating to the building identified in the received request. This building data may include a layout of the building (e.g., a floorplan and/or a three dimensional (or two dimensional or four-dimensional) model), a list of components or other items located in the building (e.g., structural or utility-related components, appliances, tools, supplies of materials, or other items), locations of these components, and/or other information about the building or its components. In some embodiments, a building database may be built by the analytics computing device including information about a plurality of different buildings. The building data may be input by homeowners, collected by prompting homeowners for information, collected by smart devices or other network-connected devices within the buildings, collected from internet sources or other available sources. This information may include, for example, images, instructions, and other information relating to the building, and be shared or accessed by others who may access or maintain the building (e.g., while the homeowner is away) or future owners of the building if the building is sold. The building data may include instructional information relating to addressing or fixing issues that arise with the building such as, for example, leaks, fires, electrical issues, damage, broken appliances, intruders, and/or other such issues. Additionally, the building data may include instructional information relating to routine tasks such as, for example, cleaning, feeding pets, watering plants, cleaning, sorting and storing mail and packages, and/or other such tasks.

In exemplary embodiments, the analytics computing device may be further configured to identify, based upon the inquiry, one or more target components of the plurality of components of the building. The target components may relate to the inquiry. For example, if the inquiry relates to a leak in a home, relevant target components may include a valve for temporarily shutting off the water, pipes or other fixtures that may be leaking and points of access for these pipes or fixtures, and any tools that may be available in the home to repair the leak. In some embodiments, chatbots and/or generative artificial intelligence (AI) applications (e.g., ChatGPT or ChatGPT-based) may be used to parse the inputted inquiries and identify relevant target components based upon the inquiries. Accordingly, the inquiries may be submitted in a variety of different formats interpretable by the chatbots and/or AI applications, such as natural language (e.g., text or speech), videos, images, sound recordings, and/or any other inputs that may be used to identify issues within a building and target components of the building that may relate to the identified issues.

In exemplary embodiments, the analytics computing device may be further configured to generate an image overlay based upon the positional data and the building data, and may cause the user computing device to display the image stream with the generated image overlay. The image overlay may include one or more indicators corresponding to locations of the one or more target components. For example, when viewed using the user computing device, the overlay may be positioned within the image stream to show locations of the target components. The overlay may be continually updated based upon a position of the user computing device, so that if the user computing device is moved, components of the image overlay may move within the image stream to retain their virtual position with respect to actual components of the target components.

In exemplary embodiments, the analytics computing device may cause the user computing device to display the image stream with the generated image overlay. For example, in some embodiments, the user interface may include augmented reality (AR) and/or virtual reality (VR) display functionality, which may be displayed by the user computing device. If the user computing device is a mobile device such as a smart phone or tablet, the user interface and overlay may be displayed through a mobile application (“app”) executed by the user computing device. Additionally, if the user computing device is, includes, and/or is in communication with, a headset (e.g., a Google Glass or Oculus Quest), the headset may display the user interface including the overlay. The user computing device may provide data, such as its current position and orientation, to the analytics computing device may continually update the overlay, for example, so that if the user computing device is moved, components of the image overlay may move within the image stream to retain their virtual position with respect to actual components of the target components. The analytics computing device may cause the user computing device to perform different responses, such as audible feedback (e.g., alarms and/or audible instructions) and/or haptic feedback (e.g., vibrations), based upon a position and/or orientation and/or other data (e.g., image data) received from the user computing device. For example, if this data indicates that the user is near a dangerous condition in the building (e.g., fire, high temperatures, exposed wires and/or high voltages, etc.), the user computing device may produce alarms and/or haptic feedback. In some embodiments, AI and/or machine learning techniques may be used to determine when, based upon feedback received from the user computing device, conditions are present that warrant such responses from the user computing device.

### Generating and Retrieving Building Data

In the exemplary embodiment, the computing device is configured to retrieve building data in response to receiving a request identifying a building (e.g., a home) and an inquiry relating to the building. Such an inquiry may be input by a user using a user computing device, or in some cases, generated automatically in response to a detection of an issue in the building (e.g., using sensors or smart devices). The building data may include data input or uploaded by a homeowner and/or contractors responsible for the building (e.g., text input, instructions, images, responses to prompts and/or questionnaires, blueprints, floor plans, CAD files, images, LIDAR scans, data generated by sensors and/or smart devices, etc.), and/or other data that may be derived from this input data (e.g., using AI and/or machine learning techniques). This data may be stored in a building database, for example, in association with a building address or other identifier associated with the building, homeowner, and/or persons otherwise responsible for the building. This information may be shared or accessed by others who may access or maintain the building (e.g., while the homeowner is away) or future owners of the building if the building is sold.

In response to receiving an inquiry from a user computing device, the analytics computing device may identify a building and building data associated with the building based upon the inquiry, and perform a lookup in the building database to identify information relevant for generating a response to the inquiry.

In some embodiments, the received building information may include information relating the structure of the building, such as locations of the building that would be useful or dangerous to access in a given situation. For example, if an electrical issue is occurring, locations of wires, whether the wires are active, appliances relating to the issue, locations circuit breakers and/or switches, and locations electrical sensors may be retrieved. In another example, if a leak or other plumbing issue is occurring, locations of pipes, material and sizes of pipes, plumbing fixtures relating to the issue, locations of valves (e.g., manual and/or smart valves), locations of shut-off valves (e.g., manual and/or smart shut-off valves), instructions on how to access valves (e.g., physically and/or using a relevant smart valve app), locations of tools for fixing or otherwise addressing the leak, detected damage (e.g., roof or plumbing damage resulting in water and/or damage resulting from the leak), locations or electricity monitoring sensors and devices, and/or locations of water flow, water sensors, flow sensors, and/or leak sensors may be retrieved.

In another example, if a fire is occurring, locations of fire extinguishers or other fire suppression systems, fire walls, fire doors, fire alarm triggers, sprinklers and/or other water sources, information relevant to rescuing individuals (e.g., locations of individuals or hazards to rescue personnel), and/or locations of smoke detectors, water sensors, lights, cameras, and/or other relevant sensors may be retrieved. In another example, if a structural issue (e.g., roof damage and/or a breach of the building's exterior by an animal or falling tree) has occurred, a location of the damage and/or tools for fixing or temporarily mitigating the damage (e.g., tarps) may be retrieved. In another example, if a technological issue (e.g., computer and/or network outage or failure), locations of and other information and instructions relating to computers and/or other relevant devices (e.g., modems, routers, smart devices, cameras, video recorders, audio recorders) may be retrieved.

In another example, rather than an issue with the building, information may be retrieved relating to routine tasks, such as instructions for cleaning, feeding pets, watering plants, cleaning, sorting and storing mail and packages, and/or other such tasks. It should be appreciated that the analytics computing device may also access any other type of data relevant to addressing these and/or other issues that may occur in a home or building.

In some embodiments, the computing device may receive building data from one or more user computing devices (e.g., mobile phones), carried by individuals present in the building. For example, the user computing devices may include sensors (e.g., accelerometers, gyroscopes, global positioning system (GPS), cameras, microphones, etc.) or otherwise be configured to receive data from sensors (e.g., sensors integrated into the building). Such sensors may generate data that describes, for example, the position and orientation of the user within the building and/or additional data relating to the status of the building (e.g., images). The user computing devices may be configured to execute a mobile application (“app”) that causes the user computing device to collect, store, and transmit this data to the analytics computing device.

In some embodiments, the building data may be transmitted to and/or retrieved by the analytics computing device in response to a detection of a situation or issue within the building. For example, the app executing on the user computing device may cause the user computing device to detect when an issue (e.g., a leak, fire, or break-in) has occurred (e.g., using sensors and/or smart devices located in the building), and transmit an indication to the analytics computing device that such an issue may have occurred, along with other relevant building data.

In some embodiments, the building may include a building computing device capable of communication with the analytics computing device (e.g., through a cable, fiber-optic, cellular, radio, and/or other communications network). In such embodiments, similar to the user computing device describe above, building computing device may be configured to transmit sensor data to the analytics computing device and/or detect an issue with the building based upon sensor data (e.g., by comparing sensor data to one or more predefined thresholds). The building may include various sensors such as, for example, cameras (e.g., outward-facing and/or passenger-facing cameras), microphones, water sensors, smoke and/or fire sensors, electrical sensors, electricity monitoring devices or sensors, and/or other sensors, which may be used to generate data based upon which issues with the building may be detected and determinations about the nature of the issue may be made. In some embodiments, the analytics computing device may receive building data or sensor data from other user computing devices, such as those associated with individuals present in the building.

For example, a user computing device (e.g., a smart phone and/or tablet) may be configured to execute an app that causes the user computing device to capture images of or within the building (e.g., using a camera or other sensors of the user computing device) and transmit the images to the analytics computing device for analysis. For instance, the analytics computing device may utilize optical character recognition (OCR), AI, and/or machine learning techniques to identify, for example, components of the home and other information relating to these components (e.g., manufacturer and model, instructions and/or manuals, potential hazards, etc.). In some such embodiments, rather than at the analytics computing device, some or all of this analysis of images may be performed at the user computing device, and the derived information may then be transmitted to the analytics computing device. In some embodiments, other types of devices, such as drones, vehicles, or user computing devices of other individuals in the area, may generate building data or sensor data.

In some embodiments, building data, images, sounds, or other sensor data retrieved by the analytics computing device may be aggregated used to make determinations and/or predictions. F For example, AI and/or machine learning techniques and/or other algorithms may be applied to this data generate an appropriate response for an inquiry relating to a building and/or issue detected with a building.

Accordingly, such data may be used for determining insurance premiums and/or developing recommendations for homeowners, contractors or other home service personnel, agencies that manage homes and/or buildings, and/or rescue personnel for improving safety of homes and/or buildings. For example, if certain components or configurations of components of a home are correlated with failure, damage to the building, or danger to occupants of the building, the analytics computing device may generate notifications for homeowners or those responsible for buildings to take preventative action.

### Generating a User Interface

In the exemplary embodiment, the analytics computing device may be configured to generate a user interface. The user interface may be displayed by a user computing device such as the user computing device described above. The user interface may display information about the building to respond to submitted inquiries and/or provide instructions on how to address issues detected in the building.

Based upon the retrieved building information, the computing device may identify, one or more target components of a plurality of components of the building relating to the input inquiry or issue identified with the building. For example, if an inquiry on how to fix a leak is submitted and/or a leak is detected, the analytics computing device may identify pipes that may be leaking, access points, valves, and/or tools that may be used to fix the leak or leaks that are located in the building.

The user interface displayed by the user computing device may include a representation of the building (e.g., an image or video stream and/or a virtual image) with an overlay displayed over the representation. For example, the overlay may illustrate locations of the target components within the building. In addition, the overlay may include other information, such as text instructions, labels, arrows, indicators, or other virtual objects that may provide relevant information to the user.

In some embodiments, the user interface including the building information may be displayed through an app executing on, for example, the user computing device. For example, the computing device may generate content data configured to cause the user computing device to display the user interface. In some embodiments, the computing device may identify one or more user computing devices (e.g., based upon a geographic location of the building and/or user computing devices registered as being associated with individuals taking care of the building) associated with the building. The computing device may cause the app executing on the identified user computing devices to generate a push notification, and/or transmit a text message, email, and/or other message, prompting a user of the user computing device to open the app and access the user interface.

In some embodiments, the analytics computing device may utilize artificial intelligence (AI), machine learning, and/or chatbot programs (e.g., ChatGPT) to generate textual information to include in the user interface. In some such embodiments, users may submit natural language queries (e.g., via text and/or voice), based upon which the computing device may generate a response (e.g., including information derived from the building data and/or other sensor) to be presented within the user interface. This information may include instructions on how to address certain situations relating to the inquiry. For example, if a leaking pipe is present in the building, the user may be instructed to turn off a certain valve (a location of which may also be indicated by the overlay), how to access the leaking portion of the pipe, where tools are to fix the pipe (a location of which may also be indicated by the overlay), and how to use the tools to fix the pipe. In some embodiments, the computing device my provide this information only to users preauthorized by, for example, a corresponding homeowner and/or person in charge of caring for a building.

In some embodiments, the user interface may include AR and/or VR functionality. In one example, the user computing device may be held so that a camera of the user computing device captures a live image, and the image may be displayed by the user computing device along with overlayed information. For example, the locations of identified target components of the building may be shown as overlay on the image along with addition information (e.g., text instructions, labels, arrows, indicators, or other virtual objects).

In another example, the user computing device may include or be configured for communication with an AR and/or VR headset (e.g., an Oculus Quest or Google Glass), which may display the overlay information within the user's field of view. In either example, the display may be continually updated (e.g., based upon a position and orientation of the camera and/or headset with respect to the building), so that the overlay corresponds to an actual location of the identified target components with respect to the camera and/or headset. In some embodiments, images captured by the user computing device and/or headset may be saved and/or a virtual image of the building may be generated, enabling users to view the AR or VR interface without being present at the building.

In some embodiments, the user computing device and/or headset may be further capable of projecting the overlay within the building. For example, the user computing device and/or headset may include a projector that the user may orient towards and/or within the building to illuminate surfaces of the building with the overlay pattern. Such a projected overlay enables a group of individuals to view the overlay simultaneously.

In some embodiments, the computing device may include additional content for inclusion in the user interface. For example, users may view a library of building information or information relating to components of a building (e.g., instruction manuals, etc.), so that users can research certain components of a building prior to using or repairing these components. In some such embodiments, the user interface may include training videos illustrating how to use and/or repair such components.

At least one technical problems addressed by this system may include: (a) inability of computing devices to identify provide a user interface identifying locations of components within a home or other building based upon a request for information; (b) inability of computing devices to provide building information to individuals taking care of or responding to issues within a home or other building without a need for the individuals to manually perform searches using the computing device; and/or (c) inability of user interfaces to provide dynamic and/or real time information to individuals about locations of components within a home or other building using an augmented reality or virtual reality interface.

A technical effect of the systems and processes described herein may be achieved by performing at least one of the following: (a) receiving, from a user computing device, a request identifying (i) a building, (ii) an inquiry relating to the building, (iii) positional data relating to a position of the user computing device, and (iv) an image stream generated by a camera of the user computing device; (b) retrieving building data relating to the building, the building data indicating a location of a plurality of components of the building; (c) identifying, based upon the inquiry, one or more target components of the plurality of components of the building, the target components relating to the inquiry; (d) generating, based upon the positional data and the building data, an image overlay including one or more indicators corresponding to locations of the one or more target components; and (e) causing the user computing device to display the image stream with the generated image overlay

At least one technical effect achieved by this system may be one of: (a) ability for computing devices to identify provide a user interface identifying locations of components within a home or other building based upon a request for information by accessing a database of building data relating to the building; (b) ability for computing devices to provide building information to individuals taking care of or responding to issues within a home or other building without a need for the individuals to manually perform searches using the computing device by using chatbot, AI, or other analytics to identify relevant building data based upon an input request for information; and (c) ability for user interfaces to provide dynamic and/or real time information to individuals about locations of components within a home or other building using graphically presented (e.g., as a floorplan, schematic, and/or an AR or VR interface) building data.

### Exemplary Computer System

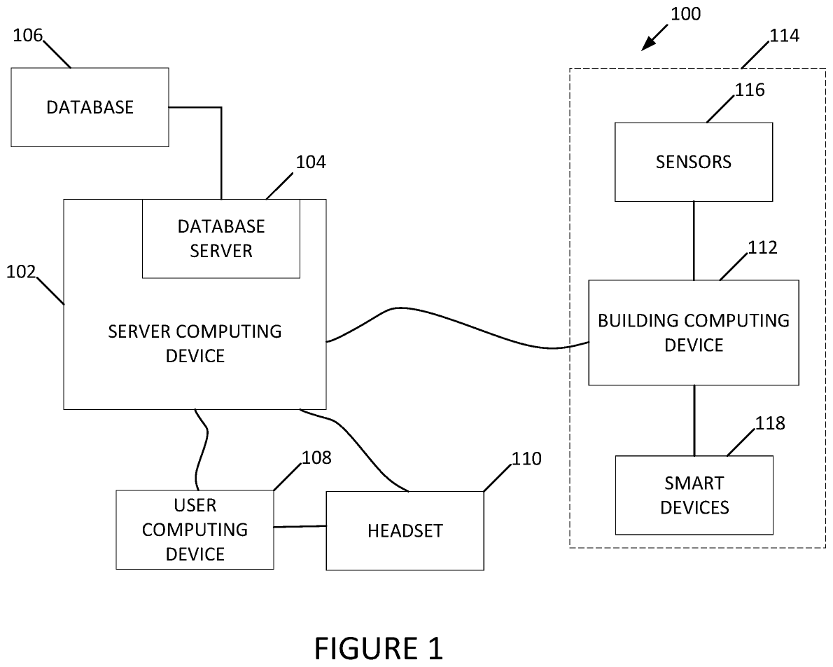

FIG. 1 depicts an exemplary computer system 100. Computer system 100 may include an analytics computing device 102 including a database server 104. Computer system 100 may further include, in communication with analytics computing device 102, one or more of a database 106, at least one user computing device 108, and/or a headset 110. In some embodiments, user computing device 108 may be configured to be communicatively linked to headset 110. In some embodiments, computer system 100 may further include at least one building computing device 112 disposed in and/or corresponding to a building 114 (e.g., a home), one or more sensors 116 disposed in building 114, and one or more smart devices 118 disposed in building 114. Smart devices 118 may include, for example, smart appliances, smart speakers, home monitoring devices (e.g., cameras, speakers, power monitoring devices, water or leak sensors or devices, other devices including sensors), home control devices (e.g., smart thermostats, smart light switches and/or bulbs, smart valves), or other connected devices.

In the exemplary embodiment, analytics computing device 102 is configured to retrieve building data in response to receiving a request identifying building 114 (e.g., a home) and an inquiry relating to building 114. Such an inquiry may be input by a user using user computing device 108, or in some cases, generated automatically in response to a detection of an issue in building 114 (e.g., using sensors 116 or smart devices 118). The building data may include data input or uploaded by a homeowner and/or contractors responsible for building 114 (e.g., text input, instructions, images, responses to prompts and/or questionnaires, blueprints, floor plans, CAD files, images, LIDAR scans, data generated by sensors 116 and/or smart devices 118, etc.), and/or other data that may be derived from this input data (e.g., using AI and/or machine learning techniques). This data may be stored in a building database (e.g., stored in database 106), for example, in association with a building address or other identifier associated with building 114, homeowner, and/or persons otherwise responsible for building 114. This information may be shared or accessed by others who may access or maintain building 114 (e.g., while the homeowner is away) or future owners of building 114 if building 114 is sold.

In response to receiving an inquiry from user computing device 108, analytics computing device 102 may identify building 114 and building data associated with a building 114 based upon the inquiry, and perform a lookup in the building database to identify information relevant for generating a response to the inquiry.

In some embodiments, the received building information may include information relating the structure of building 114, such as locations of building 114 that would be useful or dangerous to access in a given situation. For example, if an electrical issue is occurring, locations of wires, whether the wires are active, appliances relating to the issue, locations circuit breakers and/or switches, and locations electrical sensors may be retrieved. In another example, if a leak or other plumbing issue is occurring, locations of pipes, material and sizes of pipes, plumbing fixtures relating to the issue, locations of valves (e.g., manual and/or smart valves, including shut-off valves), instructions on how to access valves (e.g., physically and/or using a relevant smart valve app), locations of tools for fixing or otherwise addressing the leak, detected damage (e.g., roof or plumbing damage resulting in water and/or damage resulting from the leak, and/or damage determined from data generated or collected by water, moisture, odor or smell, or leak sensors or detectors), and/or locations of water flow sensors, water sensors, moisture sensors, odor sensors, and/or leak sensors and/or devices may be retrieved.

In another example, if a fire is occurring, locations of fire extinguishers or other fire suppression systems, fire walls, fire doors, fire alarm triggers, sprinklers and/or other water sources, information relevant to rescuing individuals (e.g., locations of individuals or hazards to rescue personnel), and/or locations of smoke detectors, water sensors, leak sensors, moisture sensors, odor sensors, and/or other relevant sensors 116 may be retrieved. In another example, if a structural issue (e.g., roof damage and/or a breach of an exterior of building 114 by an animal or falling tree) has occurred, a location of the damage and/or tools for fixing or temporarily mitigating the damage (e.g., tarps) may be retrieved.

In another example, if a technological issue (e.g., computer and/or network outage or failure), locations of and other information and instructions relating to computers and/or other relevant devices (e.g., modems, routers, smart devices 118) may be retrieved. In another example, rather than an issue with building 114, information may be retrieved relating to routine tasks, such as instructions for cleaning, feeding pets, watering plants, cleaning, sorting and storing mail and packages, and/or other such tasks. It should be appreciated that analytics computing device 102 may also access any other type of data relevant to addressing these and/or other issues that may occur in a home or building.

In some embodiments, analytics computing device 102 may receive building data from one or more user computing devices 108 (e.g., mobile phones), carried by individuals present in building 114. For example, user computing device 108 may include sensors (e.g., accelerometers, gyroscopes, global positioning system (GPS), cameras, microphones, etc.) or otherwise be configured to receive data from sensors 116 (e.g., sensors integrated into building 114). Such sensors may generate data that describes, for example, the position and orientation of the user within building 114 and/or additional data relating to the status of building 114 (e.g., images). User computing device 108 may be configured to execute a mobile application (“app”) that causes user computing device 108 to collect, store, and transmit this data to analytics computing device 102.

In some embodiments, the building data may be transmitted to and/or retrieved by analytics computing device 102 in response to a detection of a situation or issue within building 114. For example, the app executing on user computing device 108 may cause user computing device 108 to detect when an issue (e.g., a leak, broken or leaking piping or toilet, fire, or break-in) has occurred (e.g., using sensors 116 and/or smart devices 118 located in building 114), and transmit an indication to analytics computing device 102 that such an issue may have occurred, along with other relevant building data.

In some embodiments, building 114 may include building computing device 112 capable of communication with analytics computing device 102 (e.g., through a cable, fiber-optic, cellular, radio, and/or other communications network). In such embodiments, similar to user computing device 108 describe above, building computing device 112 may be configured to transmit sensor data to analytics computing device 102 and/or detect an issue with building 114 based upon sensor data (e.g., by comparing sensor data to one or more predefined thresholds). Building 114 may include various sensors 116 such as, for example, cameras (e.g., outward-facing and/or passenger-facing cameras), microphones, water sensors, leak sensors, moisture sensors, smoke and/or fire sensors, sniffing or smelling sensors, odor sensors, electrical sensors, and/or other sensors, which may be used to generate data based upon which issues with building 114 may be detected and determinations about the nature of the issue may be made.

In some embodiments, analytics computing device 102 may receive building data or sensor data from other user computing devices 108, such as those associated with individuals present in building 114. For example, user computing device 108 (e.g., a smart phone and/or tablet) may be configured to execute an app that causes the user computing device to capture images of or within building 114 (e.g., using a camera or other sensors 116 of user computing device 108) and transmit the images to analytics computing device 102 for analysis. For example, analytics computing device 102 may utilize optical character recognition (OCR), AI, and/or machine learning techniques to identify, for example, components of the home and other information relating to these components (e.g., manufacturer and model, instructions and/or manuals, potential hazards, etc.). In some such embodiments, rather than at analytics computing device 102, some or all of this analysis of images may be performed at user computing device 108, and the derived information may then be transmitted to analytics computing device 102. In some embodiments, other types of devices, such as drones, vehicles, or user computing devices 108 of other individuals in the area, may generate building data or sensor data.

In some embodiments, building data, images, sounds, or other sensor data retrieved by analytics computing device 102 may be aggregated used to make determinations and/or predictions. For example, AI and/or machine learning techniques and/or other algorithms may be applied to this data generate an appropriate response for an inquiry relating to building 114 and/or issue detected with building 114.

Accordingly, such data may be used for determining insurance premiums and/or developing recommendations for homeowners, contractors or other home service personnel, agencies that manage homes and/or buildings, and/or rescue personnel for improving safety of homes and/or buildings. For example, if certain components or configurations of components of a home are correlated with failure, damage to building 114, or danger to occupants of building 114, analytics computing device 102 may generate notifications for homeowners or those responsible for building 114 to take preventative action.

In the exemplary embodiment, analytics computing device 102 is configured to generate a user interface. The user interface may be displayed by user computing device 108 as described above. The user interface may display information about building 114 to respond to submitted inquiries and/or provide instructions on how to address issues detected in building 114.

Based upon the retrieved building information, analytics computing device 102 may identify, one or more target components of a plurality of components of building 114 relating to the input inquiry or issue identified with building 114. For example, if an inquiry on how to fix a leak is submitted and/or a leak is detected, analytics computing device 102 may identify pipes that may be leaking, access points, valves, and/or tools that may be used to fix the leak that are located in building 114.

The user interface displayed by user computing device 108 may include a representation of building 114 (e.g., an image or video stream and/or a virtual image) with an overlay displayed over the representation. For example, the overlay may illustrate locations of the target components within building 114. In addition, the overlay may include other information, such as text instructions, labels, arrows, indicators, or other virtual objects that may provide relevant information to the user.

In some embodiments, the user interface including the building information may be displayed through an app executing on, for example, user computing device 108. For example, analytics computing device 102 may generate content data configured to cause user computing device 108 to display the user interface. In some embodiments, analytics computing device 102 may identify one or more user computing devices 108 (e.g., based upon a geographic location of building 114 and/or user computing devices 108 registered as being associated with individuals taking care of building 114) associated with building 114. Analytics computing device 102 may cause the app executing on the identified user computing devices 108 to generate a push notification, and/or transmit a text message, email, and/or other message, prompting a user of user computing device 108 to open the app and access the user interface.

In some embodiments, analytics computing device 102 may utilize artificial intelligence (AI), machine learning, and/or chatbot programs (e.g., ChatGPT) to generate textual information to include in the user interface. In some such embodiments, users may submit natural language queries (e.g., via text and/or voice), based upon which analytics computing device 102 may generate a response (e.g., including information derived from the building data and/or other sensor) to be presented within the user interface. This information may include instructions on how to address certain situations relating to the inquiry. For example, if a leaking pipe is present in building 114, the user may be instructed to turn off a certain valve (a location of which may also be indicated by the overlay), how to access the leaking portion of the pipe, where tools are to fix the pipe (a location of which may also be indicated by the overlay), and how to use the tools to fix the pipe. In some embodiments, analytics computing device 102 may provide this information only to users preauthorized by, for example, a corresponding homeowner and/or person in charge of caring for building 114.

In some embodiments, the user interface may include AR and/or VR functionality. In one example, user computing device 108 may be held so that a camera of the user computing device 108 captures a live image, and the image may be displayed by user computing device 108 along with overlayed information. For example, the locations of identified target components of building 114 may be shown as overlay on the image along with addition information (e.g., text instructions, labels, arrows, indicators, or other virtual objects).

In another example, user computing device 108 may include or be configured for communication with AR and/or VR headset 110 (e.g., an Oculus Quest or Google Glass), which may display the overlay information within the user's field of view. In either example, the display may be continually updated (e.g., based upon a position and orientation of the camera and/or headset 110 with respect to building 114), so that the overlay corresponds to an actual location of the identified target components with respect to the camera and/or headset 110. In some embodiments, images captured by user computing device 108 and/or headset 110 may be saved and/or a virtual image of the building may be generated, enabling users to view the AR or VR interface without being present at building 114.

In some embodiments, user computing device 108 and/or headset 110 may be further capable of projecting the overlay within building 114. For example, user computing device 108 and/or headset 110 may include a projector that the user may orient towards and/or within building 114 to illuminate surfaces of building 114 with the overlay pattern. Such a projected overlay enables a group of individuals to view the overlay simultaneously.

In some embodiments, analytics computing device 102 may include additional content for inclusion in the user interface. For example, users may view a library of building information or information relating to components building 114 (e.g., instruction manuals, etc.), so that users can research certain components of building 114 prior to using or repairing these components. In some such embodiments, the user interface may include training videos illustrating how to use and/or repair such components.

### Exemplary Client Computing Device

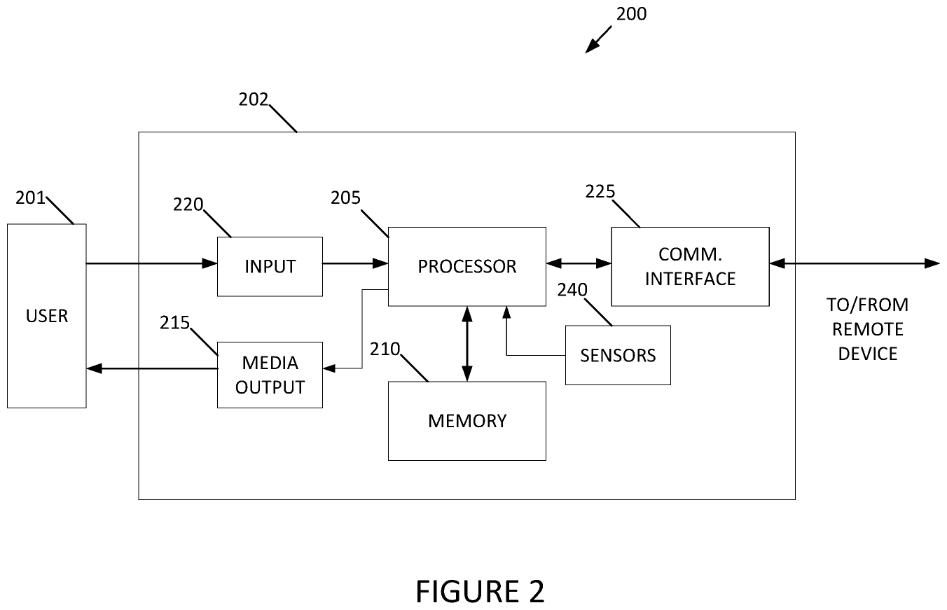

FIG. 2 depicts an exemplary client computing device 202. Client computing device 202 may be, for example, at least one of user computing device, headset 110, building computing device 112, and/or smart devices 118 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In certain exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as analytics computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 240. Sensors 240 may include, for example, accelerometers, a global positioning system (GPS), gyroscopes, water sensors, smoke or fire sensors, electrical sensors, temperature sensors, pressure sensors, humidity sensors, and/or other types of sensors. Sensors 240 may be used to collect sensor data, which may be transmitted by client computing device 202 to a remote device such as analytics computing device 102 (shown in FIG. 1).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from analytics computing device 102 (shown in FIG. 1). For example, as described with respect to FIG. 1, a mobile app may provide a user interface that enables a user to, for example, search for information and submit inquiries, view images and instructions, view AR and/or VR interfaces, and/or otherwise access information that may be provided by analytics computing device 102.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

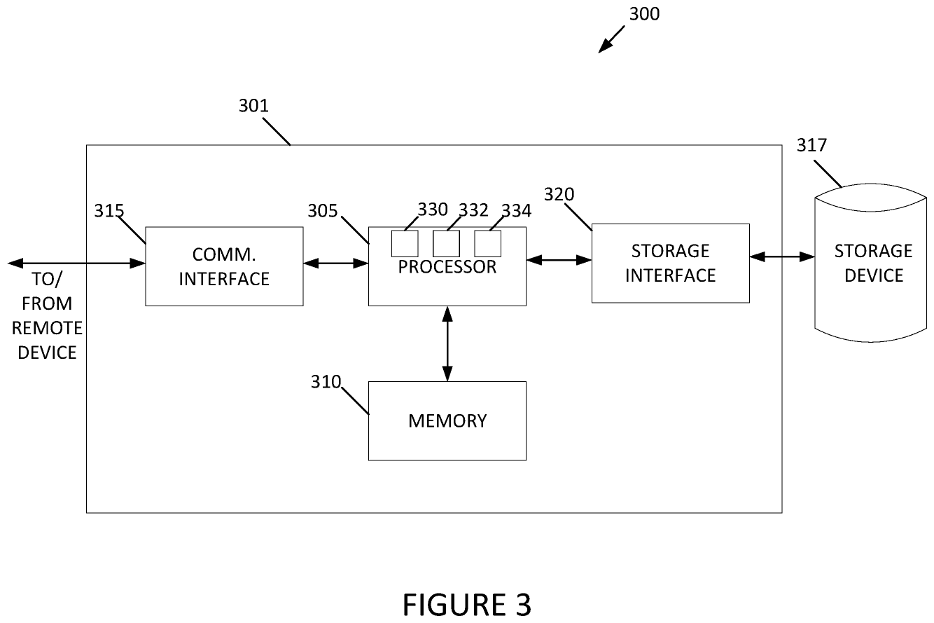

FIG. 3 depicts an exemplary server system that may be used with computer system 100 illustrated in FIG. 1. Server system 301 may be, for example, analytics computing device 102 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 may be operatively coupled to a communication interface 315 such that server system 301 is capable of communicating with user computing device 108, headset 110, and/or building computing device 112 (all shown in FIG. 1), or another server system 301. For example, communication interface 315 may receive requests from user computing device 108, headset 110, and/or building computing device 112 via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

In exemplary embodiments, processor 305 may include and/or be communicatively coupled to one or more modules for implementing the systems and methods described herein. In some embodiments, processor 305 may include one or more of a communication module 330, an analytics module 332, and/or a graphics module 334.

In some embodiments, communications module 330 may be configured to orchestrate transmitting data to and receiving data from external devices such as, for example, user computing device 108, headset 110, and/or building computing device 112. In some embodiments, analytics module 332 may be configured to make determinations based upon input data (e.g., building data and/or sensor data), for example, by performing lookups and/or queries within databases (e.g., database 106), executing OCR and/or other algorithms, and/or by executing chatbots, AI and/or machine learning techniques as described above. In some embodiments, graphics module 334 may be configured to generate graphical interfaces for display at, for example, user computing device 108 and/or headset 110.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Augmented or Virtual Reality Interface

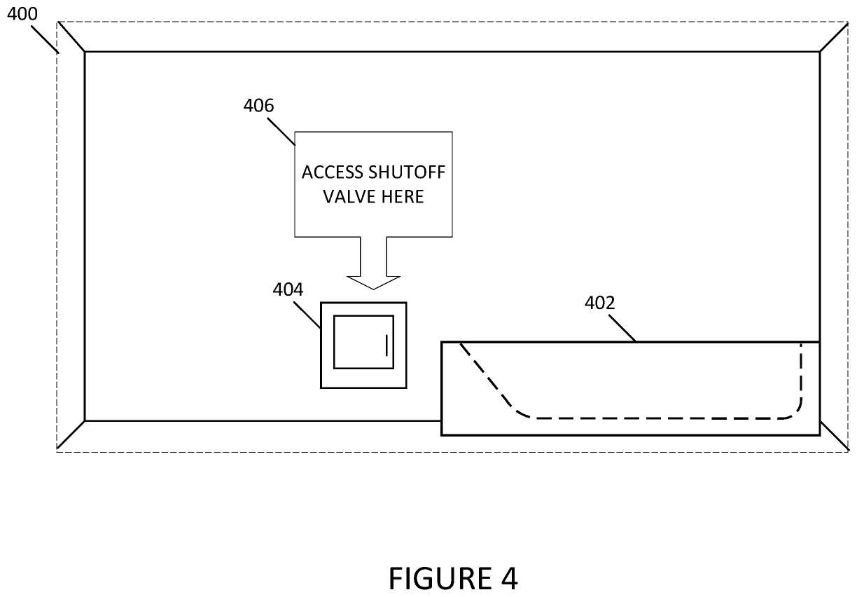

FIG. 4 depict an exemplary AR or VR interface 400. AR or VR interface 400 may be displayed by, for example, user computing device 108 and/or an AR or VR headset (e.g., headset 110). A background of AR or VR interface 400 may include photographic imagery captured by, for example, a camera of user computing device 108 and/or headset 110. This photographic imagery may be continually updated in real time (e.g., by periodically capturing new images with the camera) so that AR or VR interface 400 represents a present view of or within, for example, building 114. Alternatively, the background may be virtual representation of components of building 114, rather than a live image.

In an example case, a user may discover that a plumbing fixture 402 (e.g., a bathtub and/or its faucet) in a main bathroom of building 114 is leaking. The user may be unfamiliar with plumbing fixture 402 and/or building 114 and/or not know how to stop the leak. The user may access a mobile app using user computing device 108 and/or headset 110. The user may then input a request for information on how to stop the leak. The request may identify that the user is in building 114, or the system may determine that the user is in building 114 using a geolocation of the user (e.g., based upon GPS data from user computing device 108). The request may further include, for example, search terms, (“leaking bathtub main bathroom”), natural language text and/or speech (“How do I stop a leak in the bathtub of the main bathroom?”), selections from a menu of options, or other inputs that convey that the user wishes to stop the leak. The system may process this request and generate AR or VR interface 400 based upon the request and/or building data retrieved relating to building 114.

The generated AR or VR interface 400 may be displayed by user computing device 108 and/or headset 110 via the mobile app. AR or VR interface 400 may include the background as described above, which may be a live or virtual image. In this example case, the background may include (e.g., live images of) plumbing fixture 402 and an access door 404, which generally show plumbing fixture 402 and an access door 404 as they would appear to the naked eye of the user in building 114. In addition to photographic imagery, AR or VR interface 400 may include virtual images, such as an overlay 406, generated by the system.

In this example, overlay 406 includes an indicator pointing to access door 404, through which in this case, a shutoff valve for plumbing fixture 402 may be accessed, and instructions for stopping the leak of plumbing fixture 402 (e.g., “Access Shutoff Valve Here”). In some ceases, if the system determines that the user has opened access door 404, overlay 406 may be updated with further instructions (e.g., “Close this Shutoff Valve”).

Additionally, overlay 406 may include sounds, indicators pointing to where components of building 114 are that are out of the field of view, labels of components, and other information. The locations of overlay 406 may be continually refreshed (e.g., a location and/or angle of the camera changes with respect to the location of plumbing fixture 402 and access door 404) so that the locations of overlay 406 remains corresponding to the actual locations of plumbing fixture 402 and access door 404.

While FIG. 4 illustrates an example in which a user wishes to stop a leak, similar interfaces may be generated to provide instruction relating to other issues and/or maintenance or household tasks, which may include generated overlays similar to overlay 406.

### Exemplary Computer-Implemented Method for Generating an Augmented Reality or Virtual Reality Interface

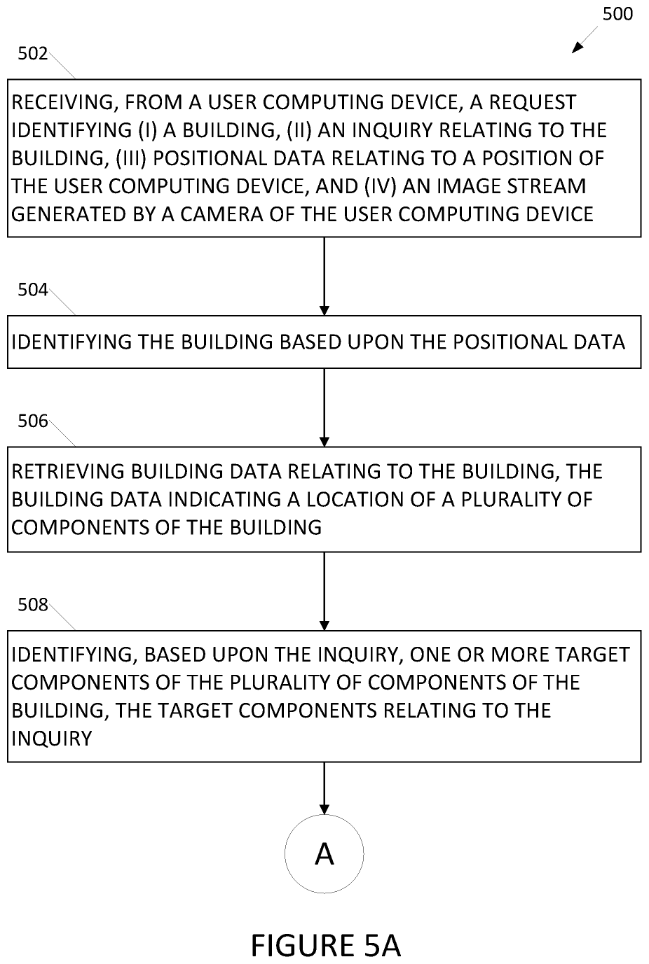

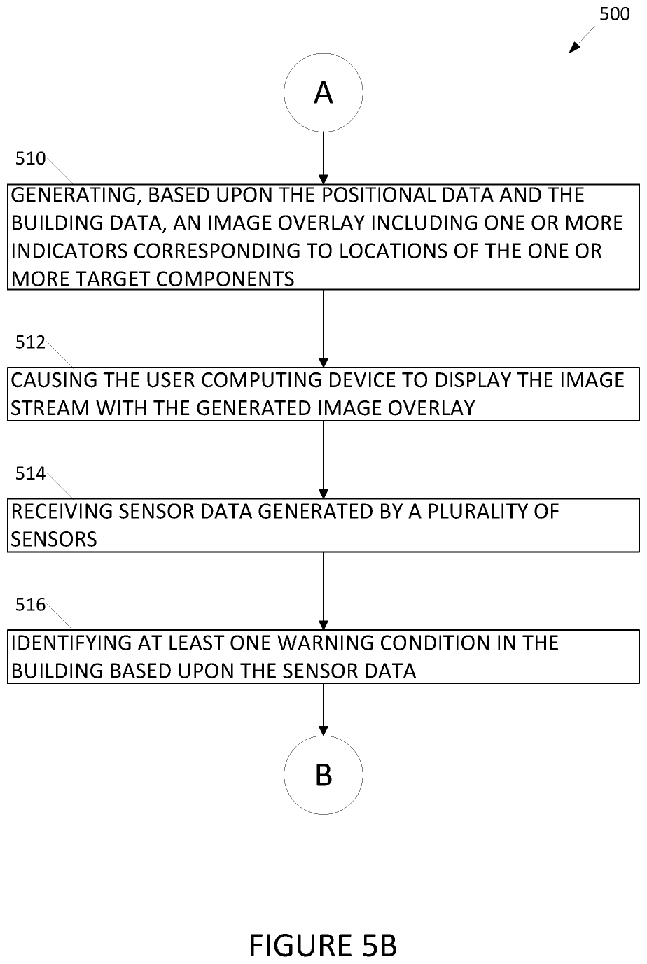

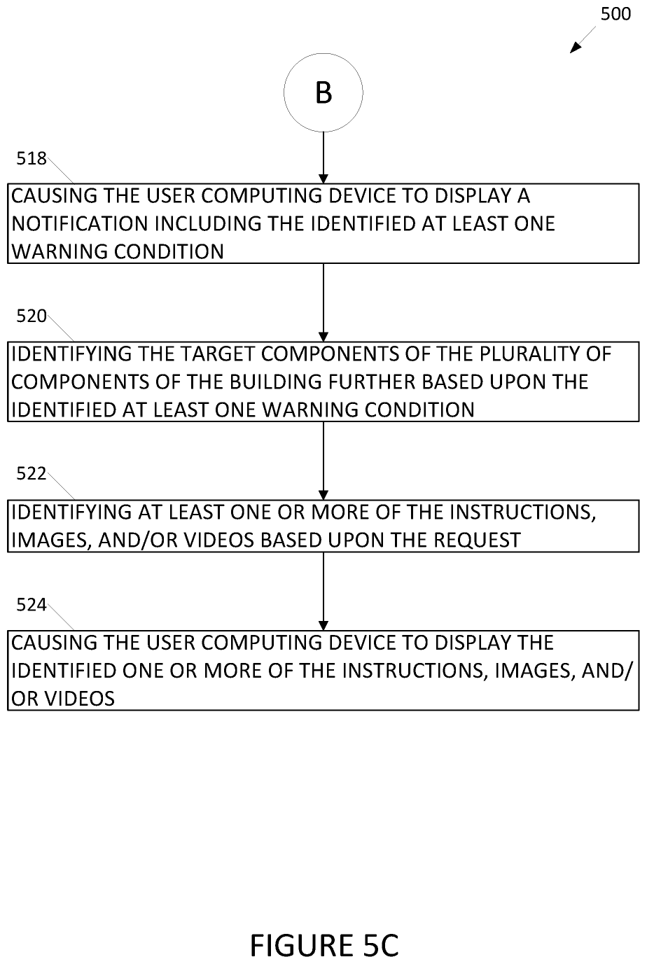

FIGS. 5A, 5B, and 5C depict a flow chart of an exemplary computer-implemented method 500 for generating AR or VR interfaces that provide locations of components within building 114 (e.g., a home or other structure) using computer system 100 (shown in FIG. 1).

In the exemplary embodiment, computer-implemented method 500 may include receiving 502, from a user computing device, a request identifying (i) a building, (ii) an inquiry relating to the building, (iii) positional data relating to a position of the user computing device, and (iv) an image stream generated by a camera of the user computing device. In some embodiments, receiving 502 the request may be performed by analytics computing device 102 (shown in FIG. 1), for example, by executing communication module 330 (shown in FIG. 3).

In some embodiments, computer-implemented method 500 further includes identifying 504 the building based upon the positional data. In some embodiments, identifying 504 the building may be performed by analytics computing device 102 (shown in FIG. 1), for example, by executing analytics module 332 (shown in FIG. 3).

In the exemplary embodiment, computer-implemented method 500 may further include retrieving 506 building data relating to the building, the building data indicating a location of a plurality of components of the building. In some embodiments, retrieving the building data may be performed by analytics computing device 102 (shown in FIG. 1), for example, by executing analytics module 332 (shown in FIG. 3).

In the exemplary embodiment, computer-implemented method 500 may further include identifying 508, based upon the inquiry, one or more target components of the plurality of components of the building, the target components relating to the inquiry. In some embodiments, identifying the target components may be performed by analytics computing device 102 (shown in FIG. 1), for example, by executing analytics module 332 (shown in FIG. 3).

In the exemplary embodiment, computer-implemented method 500 may further include generating 510, based upon the positional data and the building data, an image overlay including one or more indicators corresponding to locations of the one or more target components. In some embodiments, generating 510 the image overlay may be performed by analytics computing device 102 (shown in FIG. 1), for example, by executing graphics module 334 (shown in FIG. 3).

In the exemplary embodiment, computer-implemented method 500 may further include causing 512 the user computing device to display the image stream with the generated image overlay. In some embodiments, causing 512 the user computing device to display the image stream may be performed by analytics computing device 102 (shown in FIG. 1), for example, by executing communication module 330 (shown in FIG. 3).

In some embodiments, computer-implemented method 500 further includes receiving 514 sensor data generated by a plurality of sensors. In some embodiments, receiving 514 the sensor data may be performed by analytics computing device 102 (shown in FIG. 1), for example, by executing communication module 330 (shown in FIG. 3).

In some embodiments, computer-implemented method 500 further includes identifying 516 at least one warning condition in the building based upon the sensor data and causing 518 the user computing device to display a notification including the identified at least one warning condition. In some embodiments, identifying 516 the at least one warning condition and causing 518 the user computing device to display the notification may be performed by analytics computing device 102 (shown in FIG. 1), for example, by executing analytics module 332 and communication module 330 (shown in FIG. 3).

In some embodiments, computer-implemented method 500 further includes identifying 520 the target components of the plurality of components of the building further based upon the identified at least one warning condition. In some embodiments, identifying 520 the target components may be performed by analytics computing device 102 (shown in FIG. 1), for example, by executing analytics module 332 (shown in FIG. 3).

In some embodiments, computer-implemented method 500 further includes identifying 522 at least one or more of the instructions, images, and/or videos based upon the request and causing 524 the user computing device to display the identified one or more of the instructions, images, and/or videos. In some embodiments, identifying 522 the instructions, images, and/or videos and causing 524 the user computing device to display the identified instructions, images, and/or may be performed by analytics computing device 102 (shown in FIG. 1), for example, by executing analytics module 332 and communication module 330 (shown in FIG. 3).

### Exemplary Computer-Implemented Method for Generating an Interface Using a Chatbot

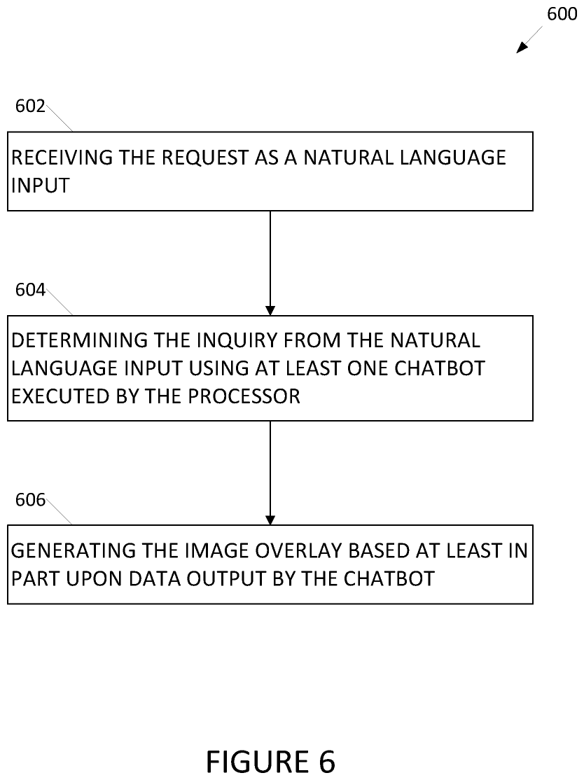

FIG. 6 depicts a flow chart of an exemplary computer-implemented method 600 for generating AR or VR interfaces using a chatbot using computer system 100 (shown in FIG. 1).

In the exemplary embodiment, computer-implemented method 600 may include receiving 602 the request as a natural language input. In some embodiments, receiving 602 the request as a natural language input may be performed by analytics computing device 102 (shown in FIG. 1), for example, by executing communication module 330 (shown in FIG. 3).

In the exemplary embodiment, computer-implemented method 600 may further include determining 604 the inquiry from the natural language input using at least one chatbot executed by the processor. In some embodiments, determining 604 the inquiry may be performed by analytics computing device 102 (shown in FIG. 1), for example, by executing analytics module 332 (shown in FIG. 3).

In the exemplary embodiment, computer-implemented method 600 may include generating 606 the image overlay based at least in part upon data output by the chatbot. In some embodiments, generating 606 the image overlay may be performed by analytics computing device 102 (shown in FIG. 1), for example, by executing graphics module 334 (shown in FIG. 3).

### Exemplary Embodiments

In an exemplary embodiment, an analytics computing device may be provided. The analytics computing device may include at least one processor and at least one memory device. The at least one processor may be configured to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the image stream with the generated image overlay. The computing device may have additional, less, or alternate functionality, including that discussed elsewhere herein.

In certain embodiments, the at least one processor may be further is in communication with a plurality of sensors disposed in the building, and the at least one processor may be further configured to receive sensor data generated by the plurality of sensors.

In some such embodiments, the at least one processor may be further configured to identify at least one warning condition in the building based upon the sensor data and cause the user computing device to display a notification including the identified at least one warning condition.

In certain such embodiments, the at least one processor may be further configured to identify the target components of the plurality of components of the building further based upon the identified at least one warning condition.

In some embodiments the at least one processor may be further configured to identify the building based upon the positional data.

In certain embodiments, the building data may further include one or more of instructions, images, and/or videos, and the at least one processor may be further configured to identify at least one or more of the instructions, images, and/or videos based upon the request and cause the user computing device to display the identified one or more of the instructions, images, and/or videos.

In some embodiments, the at least one processor may be further configured to receive the request as a natural language input and determine the inquiry from the natural language input using at least one chatbot executed by the at least one processor.

In certain such embodiments, the at least one processor may be further configured to generate the image overlay based at least in part upon data output by the chatbot.

In some such embodiments, the user computing device may be configured to execute a mobile application that causes the user computing device to at least capture the image stream and to display the user interface.

In another exemplary embodiment, a computer-implemented method may be provided. The computer-implemented method may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. The computer-implemented method may be performed by a computing device including at least one processor and at least one memory device. The method may include, via the at least one processor: (a) receiving, from a user computing device, a request identifying (i) a building, (ii) an inquiry relating to the building, (iii) positional data relating to a position of the user computing device, and/or (iv) an image stream generated by a camera of the user computing device; (b) retrieving building data relating to the building, the building data indicating a location of a plurality of components of the building; (c) identifying, based upon the inquiry, one or more target components of the plurality of components of the building, the target components relating to the inquiry; (d) generating, based upon the positional data and the building data, an image overlay including one or more indicators corresponding to locations of the one or more target components; and/or (e) causing the user computing device to display the image stream with the generated image overlay. The method may have additional, less, or alternate actions, including that discussed elsewhere herein.

In certain embodiments, the at least one processor may be further is in communication with a plurality of sensors disposed in the building, and the computer-implemented method may further include receiving sensor data generated by the plurality of sensors.

In some such embodiments, the computer-implemented method may further include identifying at least one warning condition in the building based upon the sensor data and causing the user computing device to display a notification including the identified at least one warning condition.

In certain such embodiments, the computer-implemented method may further include identifying the target components of the plurality of components of the building further based upon the identified at least one warning condition.

In some embodiments, the computer-implemented method may further include identifying the building based upon the positional data.

In certain such embodiments, the building data may further include one or more of instructions, images, and/or videos, and computer-implemented method may further include identifying at least one or more of the instructions, images, and/or videos based upon the request and causing the user computing device to display the identified one or more of the instructions, images, and/or videos.

In some embodiments, the computer-implemented method may further include receiving the request as a natural language input and determining the inquiry from the natural language input using at least one chatbot executed by the at least one processor.

In certain such embodiments, the computer-implemented method may further include generating the image overlay based at least in part upon data output by the chatbot.

In some such embodiments, the user computing device may be configured to execute a mobile application that causes the user computing device to at least capture the image stream and to display the user interface.

In another exemplary embodiment, at least one non-transitory computer readable storage medium having computer-executable instructions embodied thereon may be provided. When executed by at least one processor, the computer-executable instructions cause the at least one processor a to: (a) receive, from a user computing device, a request identifying (i) a building, (ii) an inquiry relating to the building, (iii) positional data relating to a position of the user computing device, and/or (iv) an image stream generated by a camera of the user computing device; (b) retrieve building data relating to the building, the building data indicating a location of a plurality of components of the building; (c) identify, based upon the inquiry, one or more target components of the plurality of components of the building, the target components relating to the inquiry; (d) generate, based upon the positional data and the building data, an image overlay including one or more indicators corresponding to locations of the one or more target components; and/or (e) cause the user computing device to display the image stream with the generated image overlay. The computer readable medium may have instructions that direct additional, less, or alternate functionality, including that discussed elsewhere herein.

In certain embodiments, the at least one processor may be further in communication with a plurality of sensors disposed in the building, and the computer-executable instructions may further cause the at least one processor to receive sensor data generated by the plurality of sensors.

In some such embodiments, the computer-executable instructions may further cause the at least one processor to identify at least one warning condition in the building based upon the sensor data and cause the user computing device to display a notification including the identified at least one warning condition.

In certain such embodiments, the computer-executable instructions may further cause the at least one processor to identify the target components of the plurality of components of the building further based upon the identified at least one warning condition.

In some embodiments, the computer-executable instructions may further cause the at least one processor to identify the building based upon the positional data.

In certain embodiments, the building data may further include one or more of instructions, images, and/or videos, and the computer-executable instructions may further cause the at least one processor to identify at least one or more of the instructions, images, and/or videos based upon the request and cause the user computing device to display the identified one or more of the instructions, images, and/or videos.

In some embodiments, the computer-executable instructions may further cause the at least one processor to receive the request as a natural language input and determine the inquiry from the natural language input using at least one chatbot executed by the at least one processor.

In certain such embodiments, the computer-executable instructions may further cause the at least one processor to generate the image overlay based at least in part upon data output by the chatbot.

In some such embodiments, the user computing device may be configured to execute a mobile application that causes the user computing device to at least capture the image stream and to display the user interface.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, analytics computing device 102 is configured to implement machine learning, such that analytics computing device 102 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home or building attributes with known characteristics or features. Such information may include, for example, information associated with a plurality of buildings 114.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An analytics computing device comprising at least one processor in communication with at least one memory device, the at least one processor configured to:
receive, from a user computing device, a request identifying (i) a building, (ii) an inquiry relating to the building, (iii) positional data relating to a position of the user computing device, and (iv) an image stream generated by a camera of the user computing device;
retrieve building data relating to the building, the building data indicating a location of a plurality of components of the building;
identify, based upon the inquiry, one or more target components of the plurality of components of the building, the target components relating to the inquiry;
generate, based upon the positional data and the building data, an image overlay including one or more indicators corresponding to locations of the one or more target components; and
cause the user computing device to display the image stream with the generated image overlay.

2. The analytics computing device of claim 1, wherein the at least one processor is further is in communication with a plurality of sensors disposed in the building, and wherein the at least one processor is further configured to receive sensor data generated by the plurality of sensors.

3. The analytics computing device of claim 2, wherein the at least one processor is further configured to:
identify at least one warning condition in the building based upon the sensor data; and
cause the user computing device to display a notification including the identified at least one warning condition.

4. The analytics computing device of claim 3, wherein the at least one processor is further configured to identify the target components of the plurality of components of the building further based upon the identified at least one warning condition.

5. The analytics computing device of claim 1, wherein the at least one processor is further configured to identify the building based upon the positional data.

6. The analytics computing device of claim 1, wherein the building data further includes one or more of instructions, images, and/or videos, and wherein the at least one processor is further configured to:
identify at least one or more of the instructions, images, and/or videos based upon the request; and
cause the user computing device to display the identified one or more of the instructions, images, and/or videos.

7. The analytics computing device of claim 1, wherein the at least one processor is further configured to:
receive the request as a natural language input; and
determine the inquiry from the natural language input using at least one chatbot executed by the at least one processor.

8. The analytics computing device of claim 7, wherein the at least one processor is further configured to generate the image overlay based at least in part upon data output by the chatbot.

9. The analytics computing device of claim 7, wherein the user computing device is configured to execute a mobile application that causes the user computing device to at least capture the image stream and to display the user interface.

10. A computer-implemented method performed by an analytics computing device including at least one processor in communication with at least one memory device, the computer-implemented method comprising:
receiving, from a user computing device, a request identifying (i) a building, (ii) an inquiry relating to the building, (iii) positional data relating to a position of the user computing device, and (iv) an image stream generated by a camera of the user computing device;
retrieving building data relating to the building, the building data indicating a location of a plurality of components of the building;
identifying, based upon the inquiry, one or more target components of the plurality of components of the building, the target components relating to the inquiry;
generating, based upon the positional data and the building data, an image overlay including one or more indicators corresponding to locations of the one or more target components; and
causing the user computing device to display the image stream with the generated image overlay.

11. The computer-implemented method of claim 10, wherein the at least one processor is further is in communication with a plurality of sensors disposed in the building, and wherein the computer-implemented method further comprises receiving sensor data generated by the plurality of sensors.

12. The computer-implemented method of claim 11, further comprising:
identifying at least one warning condition in the building based upon the sensor data; and
causing the user computing device to display a notification including the identified at least one warning condition.

13. The computer-implemented method of claim 12, further comprising identifying the target components of the plurality of components of the building further based upon the identified at least one warning condition.

14. The computer-implemented method of claim 10, further comprising identifying the building based upon the positional data.

15. The computer-implemented method of claim 10, wherein the building data further includes one or more of instructions, images, and/or videos, and wherein the computer-implemented method further comprises:
identifying at least one or more of the instructions, images, and/or videos based upon the request; and
causing the user computing device to display the identified one or more of the instructions, images, and/or videos.

16. The computer-implemented method of claim 10, further comprising:
receiving the request as a natural language input; and
determining the inquiry from the natural language input using at least one chatbot executed by the at least one processor.

17. The computer-implemented method of claim 16, further comprising generating the image overlay based at least in part upon data output by the chatbot.

18. The computer-implemented method of claim 16, wherein the user computing device is configured to execute a mobile application that causes the user computing device to at least capture the image stream and to display the user interface.

19. At least one non-transitory computer-readable storage media having computer-executable instructions embodied thereon, wherein when executed by an analytics computing device comprising at least one processor in communication with at least one memory device, the computer-executable instructions cause the at least one processor to:
receive, from a user computing device, a request identifying (i) a building, (ii) an inquiry relating to the building, (iii) positional data relating to a position of the user computing device, and (iv) an image stream generated by a camera of the user computing device;
retrieve building data relating to the building, the building data indicating a location of a plurality of components of the building;
identify, based upon the inquiry, one or more target components of the plurality of components of the building, the target components relating to the inquiry;
generate, based upon the positional data and the building data, an image overlay including one or more indicators corresponding to locations of the one or more target components; and
cause the user computing device to display the image stream with the generated image overlay.

20. The at least one non-transitory computer-readable storage media of claim 19, wherein the at least one processor is further is in communication with a plurality of sensors disposed in the building, and wherein the computer-executable instructions further cause the at least one processor to receive sensor data generated by the plurality of sensors.
